(19) United States
(12) Patent Application Publication
(10) Pub. No.: US 2011/0222942 A1
(43) Pub. Date: Sep. 15, 2011

(54) CONVEYING ROLLER, IMAGE FORMING APPARATUS, AND CONVEYING METHOD OF IMAGE FORMED SHEET

(75) Inventor: Satoshi HIMENO, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/025,093

(22) Filed: Feb. 10, 2011

Related U.S. Application Data
(60) Provisional application No. 61/312,046, filed on Mar. 9, 2010.

(30) Foreign Application Priority Data
Dec. 24, 2010 (JP) P2010-286835

(51) Int. Cl. G03G 15/00

(52) U.S. Cl. 399/388

(57) ABSTRACT

According to one embodiment, a conveying roller includes a rotatable first cylindrical portion which is provided with a groove on the surface thereof, a second cylindrical portion which is provided with a groove on the surface thereof, the second cylindrical portion having external diameter the same as that of the first cylindrical portion, and provided on the axis the same as that of the first cylindrical portion outside diameter as the first cylindrical portion, and a third cylindrical portion which is provided with a flat and smooth surface, the third cylindrical portion having an external diameter the same as that of the first and second cylindrical portions, and provided on the axis the same as that of the first and second cylindrical portions between the first and second cylindrical portions.

### CROSS-REFERENCE TO RELATED APPLICATION

This application is based upon and claims benefit of priority from prior U.S. Patent Application No. 61/312,046, filed on Mar. 9, 2010, entire contents of which are incorporated herein by reference.

This application is also based upon and claims benefit of priority from Japanese Patent Application No. 2010-286835, filed on Dec. 24, 2010, entire contents of which are incorporated herein by reference.

### FIELD

Exemplary embodiments described herein relate to a conveying roller, an image forming apparatus, and a conveying method of image formed sheet.

### BACKGROUND

In the image forming apparatus, such as a copy machine and a printer, the conveying roller pair for conveying an image fixed sheet, it is common to press a plastic roller and to make it follow to an image carrying surface side of the sheet where a rubber roller and a toner image were formed in an image non-formation surface side. The sheet is inserted between such pair of the conveying rollers, and the sheet is conveyed.

The sheet is heated in order to fix the toner image in fixing assembly. Therefore, hot the toner image is contacting the sheet immediately after the sheet passing through fixing assembly, and when the toner image contacts the conveying roller, a contact portion will be cooled rapidly. Therefore, there is a possibility of occurring a glossy unevenness between the conveying roller contacting portion and roller non-contacting portion.

Therefore, in order to prevent occurring of the glossy unevenness, it is hoped to diminish contact area of the conveying roller and the sheet contact. It is possible to provide grooves over entire surface of the roller for diminishing contact area to the sheet.

However, when the grooves are provided over whole surface of a roller, the roller does not rotate smoothly due to the surface unevenness, and thus there is a possibility of that problems, such as occurring of noise, may arise.

### BRIEF DESCRIPTION OF THE DRAWINGS

FIG. 1 is a schematic diagram for showing the image forming apparatus;

FIG. 2 is a perspective view showing the conveying roller pair;

FIG. 3 is perspective view showing the conveying roller which contacts the image carrying surface side of the sheet;

FIG. 4 is a front view showing the conveying roller which contacts an image carrying surface side of the sheet;

FIG. 5 is a perspective view showing the conveying roller in which the grooves are alternately formed on the first cylindrical portion and the second cylindrical portion; and

FIG. 6 is a front view showing a modification of the conveying roller.

### DETAILED DESCRIPTION

In general, according to one embodiment, there is provided a conveying roller including: a rotatable first cylindrical portion which is provided with a groove on the surface thereof; a second cylindrical portion which is provided with a groove on the surface thereof, the second cylindrical portion having external diameter the same as that of the first cylindrical portion, and provided on the axis the same as that of the first cylindrical portion outside diameter as the first cylindrical portion; and a third cylindrical portion which is provided with a flat and smooth surface, the third cylindrical portion having an external diameter the same as that of the first and second cylindrical portions, and provided on the axis the same as that of the first and second cylindrical portions between the first and second cylindrical portions.

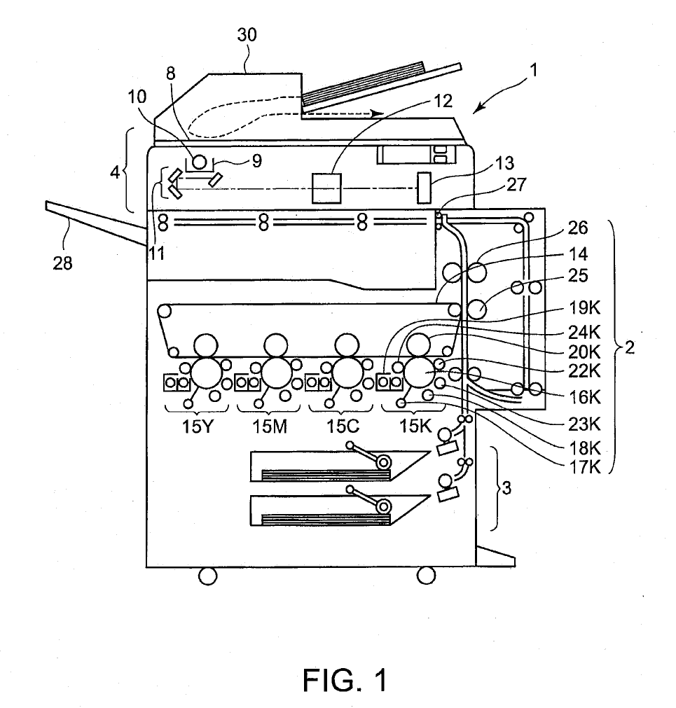

Hereafter, the embodiments will be described with reference to FIG. 1 through FIG. 6. FIG. 1 is a schematic sectional view showing the image forming apparatus with which one embodiment will be applied.

An image forming apparatus 1 includes an image reader 4 to read in documents as image data, and an image forming portion 2 to output the image data as visible image. An image forming portion 2 has an image forming unit including, e.g., a drum type photoconductor etc, as will be mentioned later, and a fixing device, etc. Further, the image forming apparatus 1 has a sheet supply unit 3 to supply a sheet P of any size to the image forming portion 2.

An image reader 4 is provided with a light permeable document table 8, a carriage 9, an exposure lamp 10, a reflection mirror 11, an imaging lens 12 for converging reflected light, and a CCD (Charge Coupled Device) 13 for converting image data effected by the reflected light to analog signal.

The image forming apparatus 1 shown in FIG. 1 is provided with each image forming units of yellow (Y), magenta (M), cyan (C), and black (K) in parallel, and then capable of executing a color-printing. As each image forming unit having the same construction and working at the same operation, the image forming units will be explained by taking the image forming unit 15K of black (B) as an example.

The image forming unit 15K is provided with a laser unit 17K for forming an electrostatic latent image on a drum-type photoconductor 16K as an image carrier, and devices disposed around the photoconductor 16K one by one, i.e., an electrifying unit 18K, a developing device 19K, a cleaner 22K, and a charge elimination lamp 23K.

As shown in FIG. 1, as to the image forming units 15K, a well-known endless-type intermediate transferring belt 14 is movably wound over the image forming units 15K by driving roller pair. Via this intermediate transferring belt 14, a primary transfer roller 20K which is a transfer member is disposed in contact with s photoconductor 16Kd. Further, on the downstream side of each image forming unit, a secondary transfer roller 25 is disposed in contact with the intermediate transfer belt 14.

A document subjected to copy is placed on the document table 8, or a well-known automatic document feeder 30 set on the document table 8. When a copy button (not shown) is operated, the document placed on the document table 8 or conveyed on the document table 8 from the automatic document feeder 30 is exposed with light from an exposure device. The exposure device is constituted by a carriage 9, an exposure lamp 10 provided in carriage 9, reflection mirror 11, and an imaging lens 12. When light is applied to the document from lower portion of the document table 8 by operating the exposure lamp 10, reflected light from the document is guided with a reflection mirror 11, and converged with an imaging lens 12. Then, reflected light image is projected on the CCD 13. Light from the exposure lamp 10 scans the document surface in synchronization with the movement of the carriage 9 (in case of FIG. 1, left-to-right movement). This scanning light is taken in the CCD 13 as image data, output from the CCD 13 in state of analog signal, and then converted to digital signal. After that, a digitized image signal is transmitted to the laser unit 17K as image data, after image processing has been performed as occasion demands. Image data converted into digital signal may be temporarily stored in recorder such as HDD (Hard Disk Drive), etc.

In image forming portion 2, when image forming starts, electrifying unit 18K applies electric charge on the peripheral surface of photoconductor 16K in rotation, and charges the peripheral surface of photoconductor 16K in uniform electric potential. Next, the laser unit 17K radiates the outer surface of the photoconductor 16K with laser beam modulated with the image data taken in the CCD 13 and then digitized therein. This laser beam scans the drum-type photoconductor along the rotation axis thereof, and forms an electrostatic latent image corresponding to image data on peripheral surface of photoconductor 16K in rotation. Further, developing powder such as toner is applied to the peripheral surface of the photoconductor 16K, and the electrostatic latent image is converted into the toner image, i.e., developed image, by the developing device 19K.

The developing device 19K is provided with a developing roller 24K formed enabling free rotation. By the developing roller 24K rotating in placed in opposite to the photoconductor 16K, toner is applied to photoconductor 16K. When the toner image is formed in peripheral surface of photoconductor 16K, the toner image is electro-statically transferred to the intermediate transfer belt 14 with the primary transfer roller 20K which contacts via the photoconductor 16K and the intermediate transfer belt 14.

Toner on the photoconductor 16K which remained without being transferred is removed from the primary transfer roller 20K by the cleaner 22K located in rotational direction downstream of the photoconductor 16K. Residual charge on the peripheral surface of the photoconductor 16K is removed by the charge elimination lamp 23K. When forming color picture, above-mentioned operation is similarly performed one by one in the image forming units 15Y, 15M, and 15C. Therefore, on the intermediate transfer belt 14, developed image of each color formed with each image forming unit is superimposed, and turns into color picture.

Toner image transferred by the intermediate transfer belt 14 is further transferred electro-statically on the sheet conveyed from the sheet supply unit 3 through a conveying path by the secondary transfer roller 25. Then, the sheet P with which the toner image was transferred is conveyed to fixing device 26, and it is fixed to the toner image transferred on the sheet by the fixing device 26. The sheet which was fixed to the toner image and image forming completed is discharged on a paper tray 28 which is a discharge portion by the conveying roller pair 27 which is a transportation portion of the sheet.

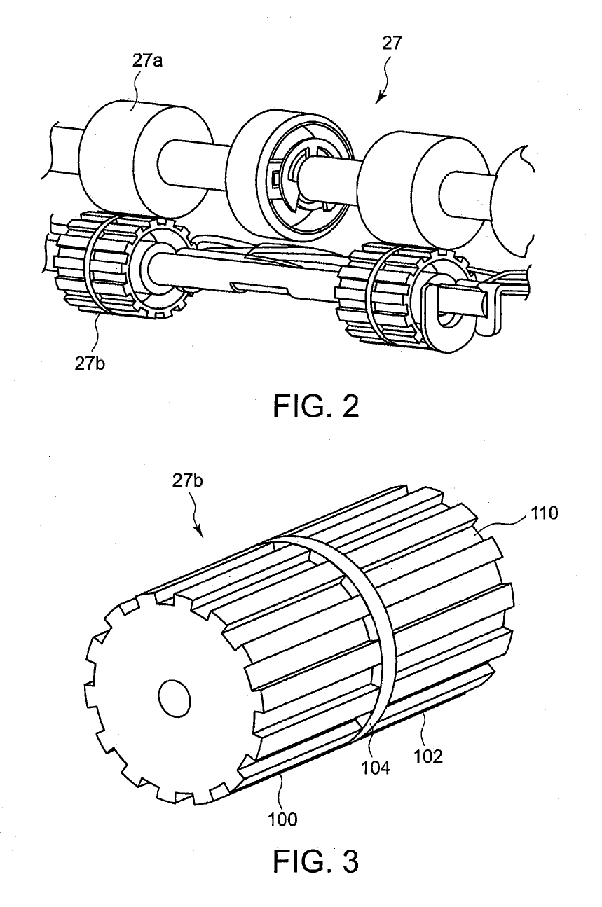

FIG. 2 is a partially expanded perspective view of the conveying roller pair 27 shown in FIG. 1. A plastic driven roller (conveying roller) 27b is formed to a rubber drive roller 27a which constitutes the conveying roller pair 27 as shown in FIG. 2. The driven roller 27b also rotates following with rotation of a rubber drive roller 27a. After image carrying surface side has contacted the driven roller 27b, the sheet with which it was fixed to picture as mentioned above is pinched by both the rollers 27a and 27b, and is conveyed.

The driven roller 27b of the conveying roller pair 27 is explained in detail. FIG. 3 is a perspective view which shows an expansion of the driven roller 27b shown in FIG. 2. As shown in FIG. 3, the driven roller 27b comprises a first cylindrical portion 100, a second cylindrical portion 102, and a third cylindrical portion 104. These are provided on the same axle. As for the first cylindrical portion 100, a plurality of grooves 110 are put in order by the circumferential direction with even interval in accordance with axis orientations. As for the second cylindrical portion 102, a plurality of the grooves 110 are similarly put in order by the circumferential direction with even interval in accordance with axis orientations. The plurality of grooves are desirable in order for way put in order at even interval to prevent the glossy unevenness of circumferential direction.

The third cylindrical portion 104 is formed between the first cylindrical portion 100 and the second cylindrical portion 102. Outside diameter of the third cylindrical portion 104 is equal to the outside diameters of the first cylindrical portion 100 and the outside diameter of the second cylindrical portion 102. Grooves are not provided on the surface of the third cylindrical portion, therefore circumference surface thereof is smooth, and the entire circumference surfaces contacts the sheet.

Thus, by the first cylindrical portion 100 and the second cylindrical portion 102 provided with grooves on their surfaces, contact area with the driven roller 27b with image carrying surface side of the sheet can be reduced. By making the surface of the third cylindrical portion 104 into smooth field, rotation with the rubber drive roller 27a is performed smoothly, and noise does not occur furthermore easily.

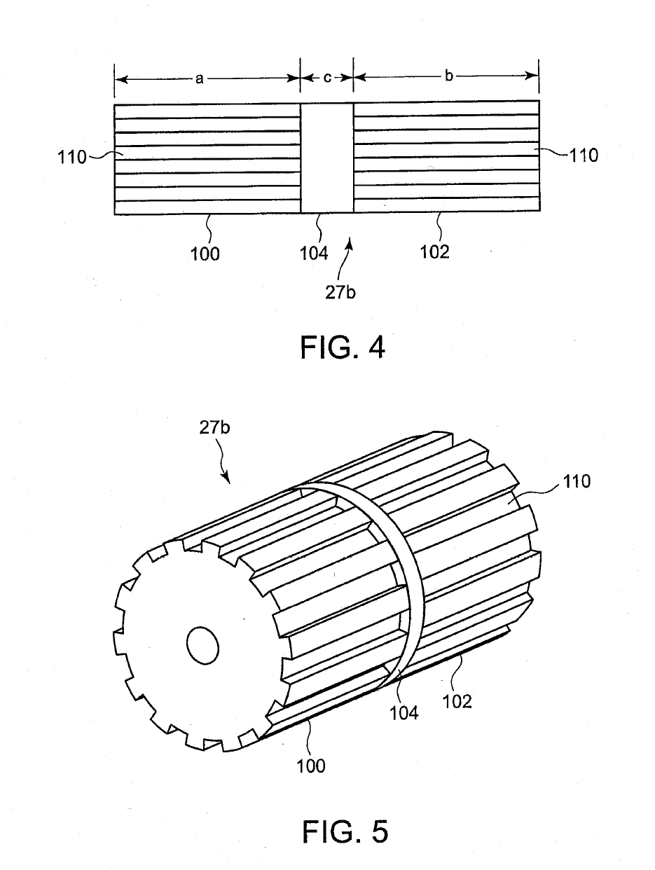

FIG. 4 is a front view showing the driven roller 27b seen from the sheet conveying direction. Referring now to FIG. 4, relations of width dimensions in axial direction of the first cylindrical portion 100, the second cylindrical portion 102, and the third cylindrical portion 104 will be described.

When a width dimension of first cylindrical portion 100 in axial direction is set to a, a width dimension of the second cylindrical portion 102 in axial direction is set to b, and a width dimension of the third cylindrical portion 104 in axial direction is set to c, relationships a>c and b>c come into effect. That is, the third cylindrical portion 104 is formed with the width dimension narrower than both the first cylindrical portion 100 and the second cylindrical portion 102. This is for diminishing area of the third cylindrical portion 104 of which entire circumference surface contacts the image carrying surface of the sheet and reducing both contact areas thereof to the sheet and the driven roller 27b.

By executing above-mentioned embodiment, on the occasion of the image fixed sheet being conveyed by the conveying roller generating of a glossy unevenness on the sheet can be prevented. Furthermore, by executing the above-mentioned embodiment, it becomes possible to convey the sheet smoothly.

Although the first cylindrical portion 100 and the second cylindrical portion 102 were provided a plurality of grooves aligning in the circumference direction, but the aligning aspect of the grooves is not limited to the above one. In short, the first cylindrical portion 100 and the second cylindrical portion 102 should just be a structures provided a plurality of grooves 110 in each surface, as contact area with the image carrying surface side of the sheet is reduced. For example, as shown in FIG. 5, grooves of the first cylindrical portion 100 and the second cylindrical portion 102 may be alternately positioned by shifting phases from each other. Although the contact area does not decrease as a whole, by doing in this way the sheet can be conveyed smoothly in comparison to the above-mentioned embodiment.

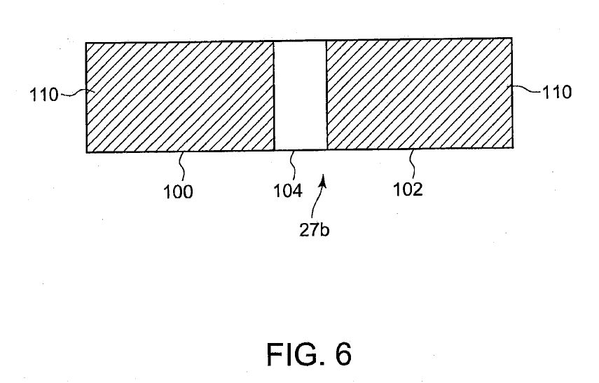

A modifications of the groove 110 on the surface of the first cylindrical portion 100 and the second cylindrical portion 102 are shown in FIG. 6.

In FIG. 6, the grooves on the first cylindrical portion 100 and the second cylindrical portion 102 are aligned so as to tilt from the rotation axis. Thus, when a plurality of grooves 110 are so provided to tilt from the rotation axis, in the rotation axis the contact surface to the sheet gets seemingly closer to the circumference surface. Therefore, the roller is able to rotate more smoothly and effect of preventing noise increases.

Although a plurality of grooves 110 shown in FIG. 6 tilt from the rotation axis, they may be helical groove. In that case, one groove is formed as if it is comprised of a plurality of tilting grooves.

While certain embodiments have been described, those embodiments have been presented by way of example only, and are not intended to limit the scope of the inventions. Indeed, novel methods and apparatuses described herein may be embodied in variety of other forms; furthermore, various omissions, substitutions and changes in the form of methods and apparatuses described herein may be made without departing from the spirits of the invention. The accompanying claims and their equivalents are intended to cover such forms or modifications as would fall within the scope and the spirits of the inventions.

What is claimed is:

1. A conveying roller comprising:
a rotatable first cylindrical portion which is provided with a groove on the surface thereof;
a second cylindrical portion which is provided with a groove on the surface thereof, the second cylindrical portion having external diameter the same as that of the first cylindrical portion, and provided on the axis the same as that of the first cylindrical portion outside diameter as the first cylindrical portion; and
a third cylindrical portion which is provided with a flat and smooth surface, the third cylindrical portion having an external diameter the same as that of the first and second cylindrical portions, and provided on the axis the same as that of the first and second cylindrical portions between the first and second cylindrical portions.

2. The conveying roller according to claim 1, wherein the first cylindrical portion and the second cylindrical portion are provided with a plurality of grooves, respectively, along the axial direction, with interval, is located in line and arranged in a circumferential direction.

3. The conveying roller according to claim 1, wherein a plurality of grooves of the first cylindrical portion and a plurality of grooves of the second cylindrical portion are provided with predetermined angle to the direction of the rotation axis.

4. The conveying roller according to claim 1, wherein the groove of the first cylindrical portion and the groove of the second cylindrical portion is formed helically, respectively.

5. The conveying roller according to claim 2, wherein the plurality of grooves of the first cylindrical portion, the plurality of grooves of the second cylindrical portion shift to circumferential direction, and are formed alternately.

6. The conveying roller according to claim 2, wherein the grooves of the first cylindrical portion and the grooves of the second cylindrical portion are put in order by circumferential direction with even interval.

7. The conveying roller according to claim 1, wherein a width dimension in axial direction of the third cylindrical portion is smaller than a width dimension in axial direction of the first cylindrical portion, and a width dimension in axial direction of the second cylindrical portion.

8. An image forming apparatus comprising:
a sheet supply unit to supply sheets;
an image forming portion to form an image by fixing a toner image on the sheet supplied from the sheet supply unit;
a conveying portion including:
a conveying roller comprising a rotatable first cylindrical portion which is provided with a groove on the surface thereof; a second cylindrical portion which is provided with a groove on the surface thereof, the second cylindrical portion having external diameter the same as that of the first cylindrical portion, and provided on the axis the same as that of the first cylindrical portion outside diameter as the first cylindrical portion; and a third cylindrical portion which is provided with a flat and smooth surface, the third cylindrical portion having an external diameter the same as those of the first and second cylindrical portions, and provided on the axis the same as that of the first and second cylindrical portions between the first and second cylindrical portions, and a drive roller configured to contact with the conveying roller, wherein the conveying portion conveys sheet in cooperation with the rotation of the drive roller by nipping the sheet with the drive roller so as to make the surface carrying fixed toner contact to the conveying roller; and
an ejection portion to eject the sheet conveyed with the conveying portion.

9. The image forming apparatus according to claim 8, wherein the first cylindrical portion and the second cylindrical portion has each a plurality of grooves which are aligned in the direction along the rotation axis with interval.

10. The image forming apparatus according to claim 8, wherein the first cylindrical portion and the second cylindrical portion has each a plurality of grooves which are provided with predetermined have axial direction and predetermined angle with the direction of rotation axis.

11. The image forming apparatus according to claim 8, wherein the groove of the first cylindrical portion and the groove of the second cylindrical portion is formed helically, respectively.

12. The image forming apparatus according to claim 9, wherein a plurality of grooves of the first cylindrical portion and a plurality of grooves of the second cylindrical portion are alternately formed by the grooves of the second cylindrical portion shifting from the grooves of the first cylindrical portion.

13. The image forming apparatus according to claim 9, wherein grooves of the first cylindrical portion and grooves of the second cylindrical portion are aligned in the circumferential direction with even interval.

14. The image forming apparatus according to claim 8, wherein a width dimension of the third cylindrical portion in the axis direction is smaller than a width dimension of the first cylindrical portion in the axis direction and a width dimension of the second cylindrical portion in the axis direction.

15. A conveying method of an image formed sheet comprising:
nipping a sheet between the conveying roller and the drive roller so as to make the toner image fixed surface contact with the conveying roller by using a rotatable first cylindrical portion having a groove on the surface thereof, a second cylindrical portion having a groove on the surface thereof, the second cylindrical portion having external diameter the same as that of the first cylindrical portion, and provided on the axis the same as that of the first cylindrical portion outside diameter as the first cylindrical portion, and third cylindrical portion having a flat and smooth surface, the third cylindrical portion having an external diameter the same as that of the first and second cylindrical portions, and provided on the axis the same as those of the first and second cylindrical portions between the first and second cylindrical portions.
